(19) United States
(12) Patent Application Publication
(10) Pub. No.: US 2008/0257000 A1
(43) Pub. Date: Oct. 23, 2008

(54) Plant Nutrient Reduction System

(75) Inventors: T. Gordon McMahon, New York, NY (US); Paul C. Porter, Jacksonville, FL (US)

Correspondence Address: LAWRENCE SUNG0- S2IPLAW, PLLC, 401 9TH STREET, NW, SUITE 900-NIXON PEABODY LLP, WASHINGTON, DC, 20004-2128, US

(73) Assignee: The Clorox Company, Oakland, CA (US)

(21) Appl. No.: 10/588,840

(22) PCT Filed: Feb. 10, 2005
(86) PCT No.: PCT/US05/04518

§ 371 Date: Sep. 18, 2007

Related U.S. Application Data
(60) Provisional application No. 60/542,884, filed on Feb. 10, 2004.

(51) Int. Cl. C05F 11/08

(52) U.S. Cl. 71/6

(57) ABSTRACT

The present invention relates to a plant nutrient reduction system comprising the application to plants of a microbially enhanced inorganic fertilizer composition wherein said application results in plant growth and yield comparable to the application of substantially greater amounts of a non-microbially enhanced fertilizer composition.

This application claims the benefit under 35 U.S.C. § 119(e) of U.S. provisional application Ser. No. 60/542,884, filed on 10 Feb. 2004, entitled “Plant Nutrient Reduction System,” which is incorporated herein by reference.

### FIELD OF THE INVENTION

This present invention relates to a plant nutrient reduction system using microbially enhanced inorganic fertilizer compositions.

### BACKGROUND OF THE INVENTION

The continuous use of chemical pesticides on plants, bushes and trees and especially those producing crops, has created an imbalance of the microbial eco-system in the soil under them. This results in the need for larger quantities of the chemical pesticides to maintain the same level of crop production, as well as an increased need for fertilizers.

One method used to try to overcome this problem is to use organic fertilizers, such as activated sludge, municipal compost, animal manures such as cow manure, and the like that provide beneficial microbes to improve crop productivity. However, a major drawback of many if not all of these organic fertilizers is the presence in them of toxic chemicals and/or toxic metals that then accumulate in the soil.

Plants grow in complex environments that contain numerous microorganisms. Soil microorganisms in particular exert effects on plants ranging from harmful effects caused by plant pathogens to beneficial effects caused by many soil microorganisms. The presence of a complex soil microbial community is widely recognized as one indicator of soil quality, which in turn results in optimized plant growth.

Several approaches to restoring soil health and maximizing plant growth have historically been used in agriculture. These approaches include amending soil with organic materials, using crop rotations, and using cover crops in between growing seasons. We now understand that these approaches improve soil quality and plant growth because they result in enhanced populations and physiological activity of soil microbes. The problem from the perspective of modern agriculture is that amending soils with large amounts of organic material and often using crop rotations and cover crops is not economically feasible, especially in high production regions such as Florida.

A practical and economically feasible alternative approach to increasing soil microbial populations is the treatment of plants and soils with cultured microbial communities. Adding selected microorganisms, principally bacteria, from among the naturally occurring soil microbial community improves soil quality and results in increased plant growth. Recently, it has been demonstrated that plants treated with beneficial bacteria particularly exhibit increased root growth.

Enhanced root growth via treatment with beneficial microorganisms leads to a more extensive root system with a larger surface area and an increased numbers of root hairs. Root surface area and numbers of root hairs relate directly to a plant's capacity to take up nutrients from soils.

Hence, plants treated with beneficial microorganisms typically exhibit enhanced “nutrient utilization efficiency”. This means that at a given level of soil fertility, plants treated with microorganisms take up more nutrients from soil and have higher levels of key nutrients in plant tissues.

The demonstration that microbial inoculants can increase nutrient utilization efficiency has led to an examination of such inoculants for the potential to maintain plant production with the use of reduced levels of fertilizers. Applied fertilizers could be reduced by 25% when beneficial microorganisms are applied to plants and the quality of plant growth and yields can be maintained at levels equivalent to those that result with full fertility rates.

### SUMMARY OF THE INVENTION

This invention relates generally to a plant nutrient reduction system using microbially enhanced inorganic fertilizer compositions. More particularly, the present invention relates to a plant nutrient reduction system comprising the application to plants of a microbially enhanced inorganic fertilizer composition wherein said application results in plant growth and yield comparable to the application of substantially greater amounts of a non-microbially enhanced fertilizer composition.

### BRIEF DESCRIPTION OF FIGURES

FIG. 1. Growth promotion during preparation of tomato transplants. Right shows plant treated with a microbially enhanced inorganic fertilizer composition. Left shows plants treated with weekly fertigation using Peter's Light 20:10:20 with minor elements. A (top) is at 3 weeks after seeding. B (bottom) is at 5 weeks after seeding. At both sample times treatment with a microbially enhanced inorganic fertilizer composition resulted in significant increases in root and shoot weight at 95% probability level.

FIG. 2. Growth promotion of sunflower roots with a microbially enhanced inorganic fertilizer composition. Right was treated with a microbially enhanced inorganic fertilizer composition. Left (control) was treated with weekly fertigation using Peter's Light 20:10:20 with minor elements.

FIG. 3. Washed roots from plants in FIG. 4. Right=control; left=a microbially enhanced inorganic fertilizer composition. The increase in root weight was significant at the 95% probability level.

FIG. 4. Enhanced plant growth of marigold with a microbially enhanced inorganic fertilizer composition (right) compared to control (left). Control plants received weekly fertigation using Peter's Light 20 with minor elements. Enhanced root mass was significant at the 95% level of probability.

FIG. 5. Growth promotion of untreated transplants. Tomato plants were grown in transplant trays for four weeks, during which time, all received standard starter fertilizer (Peter's plant starter 9:45:15 at 3 weeks after planting). Plants were transplanted to 4″ pots shown here. Plants on right were treated with a microbially enhanced inorganic fertilizer composition. Control plants on left received weekly fertigation using Peter's Light 20:10:20 with minor elements. Photo was taken 3 weeks after transplanting.

FIG. 6. Visual appearance cucumber leaves (from experiment shown in Tables 3 and 4). Right shows an older leaf from a plant treated one time with a microbially enhanced inorganic fertilizer composition; left shows a corresponding leaf on plant treated two times with Miracle Gro at the label rate.

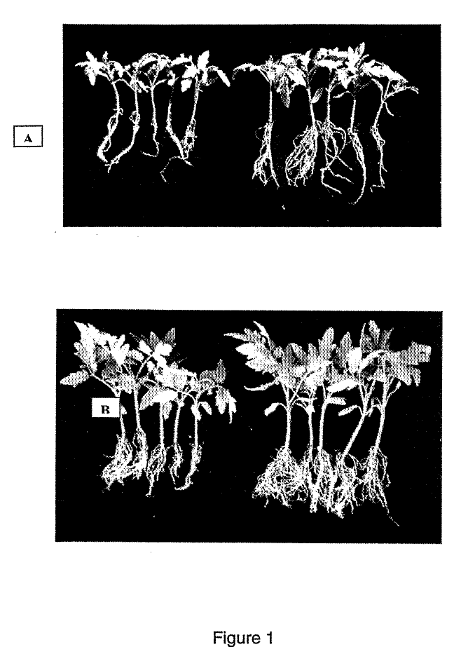

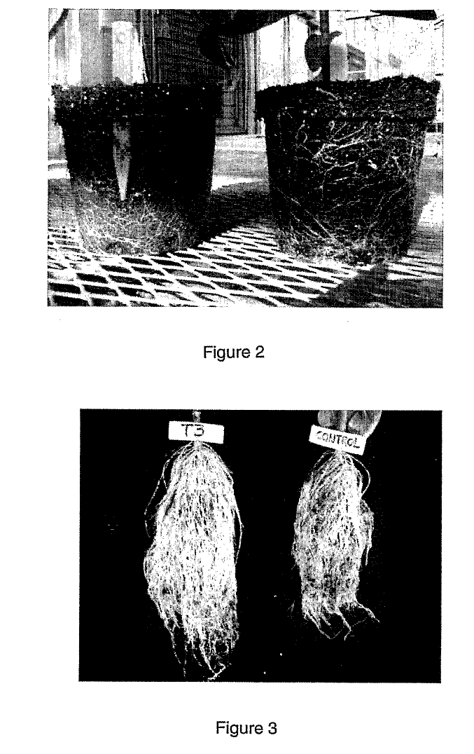

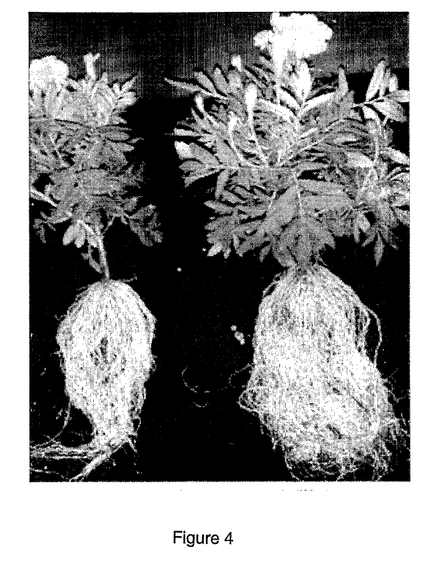

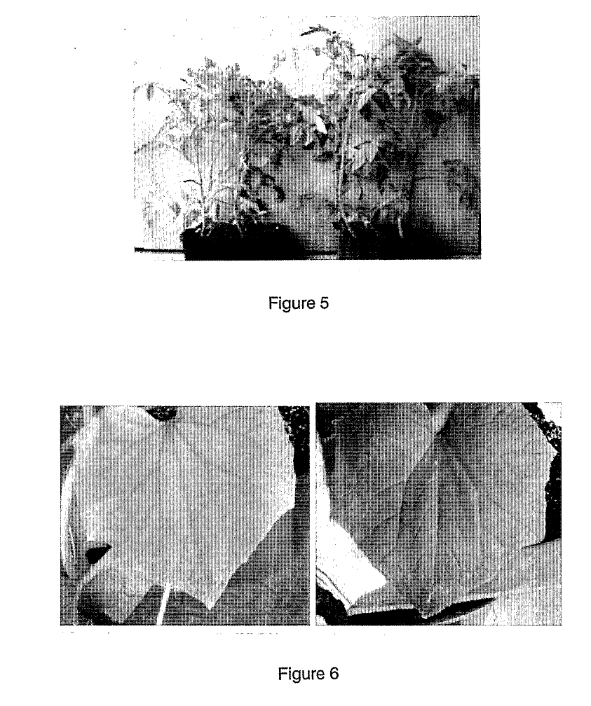

### DETAILED DESCRIPTION OF THE INVENTION

It is to be understood that this invention is not limited to the particular methodology, protocols, and reagents, etc. described herein and as such may vary. It is also to be understood that the terminology used herein is for the purpose of describing particular embodiments only, and is not intended to limit the scope of the present invention, which will be limited only by the appended claims.

As used herein and in the appended claims, the singular forms “a,” “an,” and “the” include plural reference unless the context clearly indicates otherwise. Thus, for example, reference to a microorganism is a reference to one or more such microorganisms and includes equivalents thereof known to those skilled in the art, and so forth.

Unless defined otherwise, all technical and scientific terms used herein have the same meaning as commonly understood to one of ordinary skill in the art to which this invention belongs. Although any methods, devices, and materials similar or equivalent to those described herein can be used in the practice or testing of the invention, the preferred methods, devices and materials are now described.

All publications and patents mentioned herein are incorporated herein by reference for the purpose of describing and disclosing, for example, the methodologies that are described in the publications, which might be used in connection with the presently described invention. The publications discussed herein are provided solely for their disclosure prior to the filing date of the present application. Nothing herein is to be construed as an admission that the inventors are not entitled to antedate such disclosure by virtue of prior invention or for any other reason.

Other than in the operating examples, or where otherwise indicated, all numbers expressing quantities of ingredients or reaction conditions used herein are to be understood as modified in all instances by the term “about.”

The present invention provides a plant nutrient reduction system comprising the application to plants of a microbially enhanced inorganic fertilizer composition wherein said application results in plant growth and yield comparable to the application of substantially greater amounts of a non-microbially enhanced fertilizer composition.

In one embodiment, the plant nutrient reduction system comprises:

A) an inorganic fertilizer, and

B) an effective quantity of beneficial microorganisms that a) enhance plant growth and, where applicable, crop production, and/or b) control various types of pathogens in the soil, optionally in combination with nutrients selected to maintain the viability of the microorganisms and/or increase their population. Such nutrients are well known to those skilled in microbiology.

It is to be understood that use of the term “plant” in the specification and in the claims is meant to include both crop producing and non-crop producing plants, bushes, and trees.

By way of example, the fertilizers (Component A) of the present composition may be a conventional balanced inorganic fertilizer e.g. having an N:P:K ratio of 6:10:4; 7:5:5; 9:13:7; 18:6:12; 19:8:10; 20:3:3; 25:4:4; 28:4:4; 32:10:10, and the like. These numbers show the percentage of total nitrogen, available phosphorous pentoxide (P₂O₅), and soluble potash (K₂O). This invention is of course not limited by the ratio of nitrogen to phosphorous to potassium in the inorganic fertilizer. The particular inorganic fertilizer selected will depend on the requirements of the soil to be fertilized.

Nitrogen can be present in the inorganic fertilizer in any convenient form, such anhydrous ammonia, aqueous ammonia, ammonium salts such as ammonium nitrate, calcium ammonium nitrate, ammonium phosphate, ammonium sulfate, and ammonium sulfate nitrate, sodium nitrate, potassium nitrate, urea, urea-formaldehyde reaction product, and the like.

Phosphorous can be present in any convenient water soluble form, such as CaHPO₄, Ca(H₂PO₄)₂, single superphosphate (made by reacting ground phosphate rock with 70% sulfuric acid), ammonium phosphate, nitrophosphates, monorthophosphates such as liquid ammonium polyphosphate, and the like.

Potassium can be present as commercial potash, potassium chloride, carnallite (KCl.MgCl₂.6H₂O), potassium sulfate, potassium nitrate, and the like.

Dry blended urea, diammonium phosphate, and potash is a common balanced inorganic fertilizer. While urea and possibly other nitrogen sources may be considered to be organic compounds, fertilizers containing them are predominantly inorganic and are commonly referred to as inorganic fertilizers.

In addition to the primary nutrients, i.e. nitrogen, phosphorous and potassium, secondary nutrients can be present as needed, such as calcium, magnesium, and sulfur. Also, micronutrient elements can also be added if desired such as boron, manganese, zinc, copper, iron, and molybdenum.

While balanced inorganic fertilizers are most commonly used, inorganic fertilizers deficient in one or more of nitrogen, phosphorous and potassium can be used in the practice of the invention, as soil conditions may dictate, e.g. having an N:P:K ratio of 6:2:0; 0:10:0 (bone meal); 16:20:0 (ammonium phosphate); and the like.

Component B) can be any beneficial microbial organism or combination of organisms known to enhance the quality of soil for the growth of plants. Such micororganisms include those from the genera Bacillus, Clostridium, such as Clostridium pasteurianum, Rhodopseudomonas, such as Rhodopseudomonas capsula, and Rhizobium that fix atmospheric nitrogen; phosphorous stabilizing Bacillus organisms such as Bacillus megaterium; cytokinin producing microorganisms such as Azotobacter vinelandii; and microorganisms from the genera Pseudomonas, such as Pseudomonas fluorescens, Athrobacter, such as Anthrobacter globii, Flavobacterium such as Flavobacteriium sp., Saccharomyces, such as Saccharomyces cerevisiae, and the like.

Microorganisms useful in the practice of the invention can be selected from one or more of bacteria, fungi, and viruses that have utility in soil enhancement. Viruses such as the NPV viruses (nuclear polyhedrosis virus) such as the cabbage looper nuclear polyhedrosis virus are examples of useful viruses.

Microorganisms, (bacteria, fungi and viruses) that control various types of pathogens in the soil include microorganisms that control soil-born fungal pathogens, such as Trichoderma sp., Bacillus subtilis, Penicillium sp,; microorganisms that control insects, such as Bacillus sp. e.g. Bacillus popalliae; microorganisms that act as herbicides, e.g. Alternaria sp., and the like.

All of the above microorganisms are well known and are readily available from public depositories including ATCC and NRRL.

Optional components that can also be present in the fertilizer compositions of the invention include natural enzymes, growth hormones such as the gibberellins (gibberellic acid and gibberellin plant growth hormones), and control agents including Pesticides such as acaracides and molluskicides, insecticides, fungicides, nematocides, and the like, depending of course on their compatibility with the component B) microorganisms. Compounds useful as control agents may have one activity only, but frequently are effective in more than one of the above categories. Examples of control agents that can be used in the compositions of the invention, depending on component B) compatibility, include inorganic compounds such as elementary sulfur and inorganic sulfur compounds, e.g. calcium polysulfide and sodium thiosulfate, which are effective fungicides, copper, zinc, and other metal in organics such as copper carbonate copper oxychloride, copper sulfate, and copper zinc sulfate. Organometallic compounds such as iron and tin compounds, e.g. triphenyl tin hydroxide exhibit both insecticidal and pesticidal activity. Saturated higher alkyl alcohols, either straight or branched chain, such as nonyl and decyl alcohol, can be present as insecticides. Aldehydes such as metaldehyde are an effective molluskicide, e.g. useful against snails. Carbonic acid derivatives, especially their mixed esters, are potent acaracides and fungicides, and when sulfur is also present, e.g. mixed esters of thio- and di-thiocarbonic acids, activity is further increased. 6-methylquinoxaline-2,3-dithiocyclocarbonate is an effective acaricide, fungicide, and insecticide. Carbamic acid derivatives such as aryl esters of N-methylcarbamnic acid, e.g. 1-naphthyl-N-methylcarbamate can also be used. Halogen substituted aliphatic monobasic and dibasic carboxylic acids are effective pesticides. Natural pyrethrins and their synthetic analogs are also effective pesticides. Salicylanilide is effective against leaf mold and tomato brown spot. Heterocyclic compounds possessing insecticidal and/or fungicidal activity can also be used. Halogen derivatives of benzene, such as paradichlorobenzene, are effective pesticides, often used against the sugarbeet weevil. Chitin-containing products are effective menatocides. Other compounds that can be used include aliphatic mercaptans having four or fewer carbon atoms, organic sulfides and thioacetals, nitro compounds such as chloropicrin dichloronitroethane, and chloronitropropane, copper and zinc inorganic and organic compounds, e.g. copper linoleate, copper naphthenate, etc., organophosphorous compounds of which there are well over a hundred, e.g. DDVP, tris-(2,4-diphenoxyethyl) phosphite, derivatives of mono- and dithiophosphoric acids, such as 0,0-diethyl S [2-ethylthio)-ethyl]phosphorodithioate, phosphoric acid derivatives, pyrophosphoric acid derivatives and phosphonic acid derivatives, quinones, sulfonic acid derivatives, thiocyanates and isocyanates, phytoalexins, insect killing soaps such as potassium fatty acid salts, and antiallatotropins such as 7-methoxy-2,2-dimethylchromene and the 6,7-dimethoxy analog. Diatomaceous earth can be used, which kills crawling insects.

These optional components can comprise from 0.001 to 10% or more by weight of the fertilizer composition. Also, alkalizing agents such as ground limestone and acidifying agents such as inorganic acids or acid salts can be added as needed or desired.

The fertilizer compositions of the invention can be in solid form or in the form of an aqueous solution. Solid forms include powders and larger particulate forms, e.g. from 20 to 200 mesh.

Where the fertilizer compositions are in solid form and component B) microorganisms are sensitive to light, air, or compounds in fertilizer component A) or to optional added components, the microorganisms can be separately encapsulated in water soluble coatings, e.g., dyed or undyed gelatin spheres or capsules, or by micro-encapsulation to a free flowing powder using one or more of gelatin, polyvinyl alcohol, ethylcellulose, cellulose acetate phthalate, or styrene maleic anhydride. The separately encapsulated microorganisms can then be mixed with the powder or larger particulates of component A) (which is not encapsulated) and any optional components. Encapsulation of the microorganisms preferably includes nutrients as well as the microorganisms.

The presence of the component B) microorganisms in the fertilizer compositions of the invention provides further enhancement of plant growth, and where applicable, crop production, i.e. by further enhancement is meant benefits in plant growth and crop production in addition to the benefits provided by the fertilizer component A), and/or provides control of pathogens in the soil. The fertilizer compositions of the invention can be added to soil to replenish chemical elements that have been reduced or exhausted by the soils from crops previously grown, or which have been leached from the soils as a result of poor tillage practices, overirrigation, or natural flooding, and to add nutrients to soils naturally deficient in them. The selection of the component A) inorganic fertilizer can be customized to the nutrient content of the soil to obtain particular growing objectives.

In one embodiment, the fertilizer composition comprises urea, ammonium phosphate, and potassium chloride in a ratio of N:P:K of 25:4:4 with a particle size of 100 mesh and may be intimately mixed with 1 million-500 million clostridium pasteurianum, per gram of the composition and 1 million-500 million Rhodopseudomonas capsula per gram of the composition.

In another embodiment, the fertilizer composition comprises ammonium sulfate, triple superphosphate, and carnallite in a ratio of 32:10:10 with a particle size of 50 mesh and may be intimately mixed with 1 million-100 million Bacillus megaterium or Bacillus subtilis in the form of gelatin microcapsules of about 1000 micron diameter, per gram of the composition.

In an alternative embodiment, a liquid fertilizer composition may be formulated comprising KNO₃, Ca(H₂PO₄)₂, and KCl in a ratio of N:P:K:of 18:6:12 in water in a concentration of 10% solids. About one million-100 million Athrobacter globii per gram of solids may be added to this aqueous solution.

Other embodiments of the present invention include:

### 1. Advanced All-Purpose Plant Nutrition System 15-8-10

This composition increases overall plant growth by establishing a thicker root system. This energized root system develops more root hairs, grows and supports a larger number of branches, and produces more blooms per plant. The end results are heartier plants and more abundant flowers and vegetables that are more drought resistant and are better able to survive stressful conditions. The composition may be in granular or water-soluble form.

The 15-8-10, N-P-K formulation with micronutrients represents a 45% decrease in chemicals compared with the leading plant food brands which are generally 15-30-15 or 20-20-20. This composition, with 45% less chemicals, reduces the impact on the environment. Because less chemicals are put into the soil with this composition—yet more is absorbed by the plant—there is, logically, less available as runoff.

### 2. Premium Potting Soil

Natural growth enhancers speed up the germination process for plants, resulting in a decreased in the time between planting and transplanting. Enables plants to survive transplant better and avoid shock because they carry their own soil friends and family with them in the transplanting process. The establishment of thicker root systems allows the plant to grow and support a larger number of branches, making fuller plants, and the blooms per plant are increased with the microbially enhanced inorganic fertilizer composition.

### 3. Advanced Lawn Nutrition System 20-0-10

Natural growth enhancers produce thicker, heartier lawns, shrubs and trees that require less watering and contain less chemicals than competing brands. This unique product allows users to apply 75% of the nitrogen per square foot as you would with traditional fertilizer and zero phosphorus, thus reducing chemical pollution in surface waters, groundwater, and into the atmosphere. The use of zero phosphorus is a tremendous shift from traditional lawn fertilizers, and is being mandated by states such as Michigan. This microbially enhanced inorganic fertilizer composition is used for residential lawns, turf, and a solid conditioner for trees and shrubs. The microbially enhanced inorganic fertilizer composition is used by professional golf courses and lawn services.

### EXAMPLES

Without further elaboration, it is believed that one skilled in the art, using the preceding description, can utilize the present invention to the fullest extent. The following examples are illustrative only, and not limiting of the remainder of the disclosure in any way whatsoever.

### Example 1

Evaluating the effect of cane molasses applied alone and in combination with other crop inputs on soybean development and yield demonstrates the results below, which were obtained by the following protocol. Each treatment was replicated 5 times; all at-plant treatments were applied in-furrow; 5 gal/A H₂O on each of the 6 treatments: 1. Cane Molasses at 2 qts/A+3-18-18 Starter Fertilizer at 4 gal/A; 2. Cane Molasses at 2 qts/A+Magnify™ (inoculant) at 100 ml/100 bu of seed+3-18-18 Starter Fertilizer at 4 gal/A; 3. Cane Molasses at 2 qts/A+AmiSorb® (Nutrient Absorption Enhancer™) at 2 qts/A+3-18-18 Starter Fertilizer at 4 gal/A; 4. Cane Molasses at 2 qts/A+Soil X-CYTO® (growth regulator) at 10 oz/A+3-18-18 Starter Fertilizer at 4 gal/A; 5. Cane Molasses at 2 qts/A+Naturize™ Fertility Microbes (biological) at 30 oz/A+Plasma at 30 oz/A+3-18-18 Starter Fertilizer at 4 gal/A; and 6. Control (used as baseline) (H₂O only).

Adding molasses to soil, which is known to stimulate soil microbial populations and physiological activity, increased yield of soybean by 8.7% compared to the non-fertilized control. Note that N-fertilizer is not routinely used on soybean because the N-fixing bacterium Bradyrhizobium japonicum forms root nodules and provides the plant with needed nitrogen. When the microorganisms in a microbially enhanced inorganic fertilizer composition were added along with molasses, yield was increased by 23.3% over the yield of the non-fertilized control and by 13.4% over the treatment with molasses alone.

### Example 2

Stimulation of cotton yields by the microorganisms in a microbially enhanced inorganic fertilizer composition was demonstrated in a report of treatments of three plots established ranging in size from 1.076 acres (treated) to 1.96 acres (check) with Variety Fibermax 989 with an application timing of: 1st application at planting over the row; 2nd application at 4th true leaf stage—applied with first Round-Up spray. The rate is 2.5 qts at planting+2.5 quarts@4th true leaf. The Irrigation Fields were irrigated immediately following planting and once each week during the growing season. The Soil Insecticide was Temik@3-5 lbs/acre for thrip control (no nematode infestation). No Soil Fungicide was used. The Trial Harvest was used boll buggy in all 3 trials.

No visual differences were observed during the growing season by either the grower or the extension agent. Initial expectation was that the yields would be similar. However, yield responses on the treated plots demonstrated consistent increases, with one trial more than doubling the control plot yield. Compared to the control, addition of the microorganisms in a microbially enhanced inorganic fertilizer composition increased the pounds of lint 10%, 47%, and 116% in the three trials.

### Example 3

The effect of a microbially enhanced inorganic fertilizer composition on potato growth and yield in northern Maine—2002 reports on the evaluation of three application rates of a microbially enhanced inorganic fertilizer composition on potato yield with recommended fertility levels. Several materials being marketed for the potato crop were evaluated, mostly as in-furrow treatments, in an onfarm trial. The closing disks were raised on the planter so the seed was left uncovered in the trial area. In-furrow applications of different materials were made at various rates and the furrows were closed by hand. Each plot consisted of four rows 24 feet long and was bordered by two untreated rows. All treatments were replicated four times in a randomized complete block design. The grower applied 190:230:230 lbs per acre NPK along with 2.5 lb Zn and 0.5 lb B. Leaf tissue sampling was conducted throughout the season and no nutrient deficiencies were observed. Plots treated with gibberellic acid emerged on average 2 days earlier than the other plots in the trial. Visual ranking of the plots in late July and again in early September failed to show any differences between treatments in health and vigor of the shoots. At harvest a single row eighteen feet long was dug out of the center of each plot. Potatoes were bagged by hand following the digger. Yield samples were graded by size and weighed. There were no significant differences among the treatments in total yield nor in tubers less than 2.5 inches in size. Plots treated with gibberellic acid had fewer large tubers and tended to have a greater amount of small tubers. Compared to the control, the three rates of a microbially enhanced inorganic fertilizer composition resulted in increases in marketable yield of 23.5% (treatment 1), 50.5% (treatment 2) and 17% (treatment 3).

### Example 4

Evaluating the effect of a microbially enhanced inorganic fertilizer composition on soybean development and yield presents results from a trial when different mixtures of bacteria that are now in a microbially enhanced inorganic fertilizer composition were being selected. The data show that using in-furrow application of various combinations of microorganisms from a microbially enhanced inorganic fertilizer composition resulted in yield increases, compared to the control, ranging from 17.1% for treatment 5 to 30.3% for treatment 3. Note that the capacity of microorganisms in a microbially enhanced inorganic fertilizer composition to enhance yield of soybean was independent of inoculation with rhizobia. (The designation “WI—with inoculant” refers to the use of rhizobial inoculant). Hence, a microbially enhanced inorganic fertilizer composition is compatible with rhizobia.

Collectively, the testing of a microbially enhanced inorganic fertilizer composition under greenhouse and field conditions on several crops indicates that the selected microorganisms increase plant growth and yield. Given the relationship between healthy roots and fertilizer uptake, it was reasoned that the bacteria in a microbially enhanced inorganic fertilizer composition, because of their capacity to increase root growth, could be useful in strategies to allow reduced rates of fertilizer. Testing this idea required the development of a microbially enhanced inorganic fertilizer composition.

Tests at Auburn first demonstrated that the new product form still increased plant growth and led to enhanced nutrient content in leaves compared to a standard soluble inorganic fertilizer without bacteria. Cucumber and tomato plants were grown in transplant trays without fertilizer for two weeks (cucumber) or three weeks (tomato). At the time of transplanting to 10-inch round pots, Miracle Gro (20:20:20) was applied at 1 T/gal. A microbially enhanced inorganic fertilizer composition was applied at 1 teaspoon per pot sprinkled over the top. Miracle Gro was reapplied at 10 days after transplanting. A microbially enhanced inorganic fertilizer composition was not applied a second time.

Significant increases in overall plant growth and weight of roots was noted with the a microbially enhanced inorganic fertilizer composition product, although it contained less N and P than Miracle Gro. Leaves from plants were removed at 21 days after transplanting. The same age of leaves were sampled from all plants. There were six replications per treatment. The results shown in Tables 1 and 2 show that the microbially enhanced inorganic fertilizer composition increased tissue concentrations of N and P. Such increases coupled with the reduced input rate of N and P in the microbially enhanced inorganic fertilizer composition product would be expected to result in less residual N and P in the soil. These increases also demonstrate that in the presence of the correct microbial inoculant, the input rates of fertilizer can be decreased.

TABLE 1
Plant Tissue Analysis of Cucumber Fertilized by a Microbially Enhanced
Inorganic Fertilizer Composition vs. Miracle Gro

| Treatment | % Potassium | % Phosphate | ppm Iron | % N |
|---|---|---|---|---|
| A microbially | 2.86a | 0.48a | 683a | 2.79a |
| enhanced | | | | |
| inorganic | | | | |
| fertilizer | | | | |
| composition | | | | |
| Miracle Gro | 2.58a | 0.35b | 507b | 1.32b |
| LSD_{0.05} | 0.66 | 0.05 | 114 | 0.32 |

Means within a column followed by different letters are significantly different.

TABLE 2
Plant Tissue Analysis of Tomato Fertilized by a microbially enhanced
inorganic fertilizer composition vs. Miracle Gro

| Treatment | % Potassium | % Phosphate | ppm Iron | % N |
|---|---|---|---|---|
| A microbially | 2.32a | 0.49a | 297a | 1.71a |
| enhanced | | | | |
| inorganic | | | | |
| fertilizer | | | | |
| composition | | | | |
| Miracle Gro | 2.12a | 0.42b | 154b | 0.79b |
| LSD_{0.05} | 0.47 | 0.06 | 37 | 0.21 |

Means within a column followed by different letters are significantly different.

In a follow-up study, reduced rates of a microbially enhanced inorganic fertilizer composition were applied to cucumber and tomato to test the idea that fertility rates could be lowered with no adverse effects on plant growth if the microbially enhanced inorganic fertilizer composition microbial community was applied. In this test, cucumber seedlings were grown 2 weeks without any applied fertilizer (standard practice for transplant production). Then, cucumber plugs were transplanted into 10-inch round pots. Plants were treated with Miracle Gro at the label rate of 1 tablespoon per gallon at the time of transplanting and again 10 days later. The microbially enhanced inorganic fertilizer composition product was applied at ¼ and ½ teaspoons per pot by sprinkling the granular product (fertilizer plus microorganisms) over the top of the planting mix at the time of transplanting without further applications. As shown in Table 3, a single application of a microbially enhanced inorganic fertilizer composition at both low rates promoted cucumber plant growth compared to Miracle Gro applied two times. Results were similar with tomato.

TABLE 3
Reduced fertilizer rates in the presence of microorganisms with a
microbially enhanced inorganic fertilizer composition Bionutritional
Formula (A microbially enhanced inorganic fertilizer composition)
on cucumber 3 weeks after transplanting.

| | | Runner | | |
|---|---|---|---|---|
| | Application | Length | | Leaf width |
| Treatment | Rate | (inches) | No. of Blooms | (cm) |
| A microbially | ¼ tsp at | 40** | 3.7* | 19.0 |
| enhanced | transplanting | | | |
| inorganic | | | | |
| fertilizer | | | | |
| composition | | | | |
| A microbially | ½ tsp at | 41** | 4.0+ | 21.3+ |
| enhanced | transplanting | | | |
| inorganic | | | | |
| fertilizer | | | | |
| composition | | | | |
| Miracle Gro | Water w/1 T/g | 33 | 0.7 | 15.9 |
| 15:30:15 | gal at | | | |
| | transplanting | | | |
| | and 10 days later | | | |
| LSD_{0.05} | | 7.0 | 3.6 | 4.8 |
| LSD_{0.10} | | 5.7 | 2.9 | 3.9 |

**Indicates significant difference from treatment 3 at P = 0.05.
+Indicates significant difference from treatment 3 at P = 0.10.

As shown in the tables below, on both cucumber and tomato, in addition to stimulating plant growth one application of a microbially enhanced inorganic fertilizer composition resulted in significantly higher plant accumulation of phosphorus, iron, and nitrogen compared to two applications of Miracle Gro. There were no differences between the amount of potassium in plants treated with a microbially enhanced inorganic fertilizer composition or Miracle Gro.

TABLE 4
Plant Tissue Analysis of Cucumber Fertilized by a microbially enhanced
inorganic fertilizer composition vs. Miracle Gro

| Fertilizer | % Potassium | % Phosphate | ppm Iron | % N |
|---|---|---|---|---|
| A microbially | 2.86a | 0.48a | 683 | 2.79a |
| enhanced | | | | |
| inorganic | | | | |
| fertilizer | | | | |
| composition @ | | | | |
| 1 tsp per pot at | | | | |
| transplanting | | | | |
| Miracle Gro @ | 2.58 | 0.35b | 507b | 1.32b |
| 1 T per gal at | | | | |
| transplanting | | | | |
| and 10 days later | | | | |
| LSD_{0.05} | 0.36 | 0.05 | 114 | 0.32 |

Means within a column followed by different letters are significantly different.

TABLE 5
Plant Tissue Analysis of Tomato Fertilized by a microbially enhanced
inorganic fertilizer composition vs. Miracle Gro

| Fertilizer | % Potassium | % Phosphate | ppm Iron | % N |
|---|---|---|---|---|
| A microbially | 2.32a | 0.49a | 297a | 1.71a |
| enhanced | | | | |
| inorganic | | | | |
| fertilizer | | | | |
| composition @ | | | | |
| 1 tsp per pot at | | | | |
| transplanting | | | | |
| Miracle Gro @ | 2.12a | 0.42b | 154b | 0.79b |
| 1 T per gal at | | | | |
| transplanting | | | | |
| and 10 days later | | | | |
| LSD_{0.05} | 0.47 | 0.06 | 37 | 0.21 |

Means within a column followed by different letters are significantly different.

Data from several field and greenhouse trials by other universities and private agricultural testing services also indicate that plant quality and nutrient status can be maintained when fertilizer rates are reduced if the microbial community present in a microbially enhanced inorganic fertilizer composition is used.

### Example 5

Comparative evaluation of a microbially enhanced inorganic fertilizer composition products on turfgrasses presents results of comprehensive greenhouse and field trials conducted by Professor J. B. Sartain at the University of Florida using a microbially enhanced inorganic fertilizer composition at 100%, 75%, and 50% of the recommended N-fertility level for turf in Florida. Several of the findings demonstrate that a microbially enhanced inorganic fertilizer composition is useful as a strategy to maintain plant production while decreasing fertilization rates.

Growth and Quality Field Study: Plots (6×9 ft) of St. Augustine grass was arranged in a randomized complete block design with four replications. Treatments included the following: 1) Three commercially available fertilizer sources (most likely Scotts Turfbuilder, Scotts Bonus-S and a Lesco product) applied at label recommended rates. 2) Naturize (15-4-7) applied at 100, 75 and 50% of the labeled rate of the competitor products. This generated a total of six treatments. Utilizing four replications of the treatments generated a total of 24 experimental units. Treatments were applied on a monthly basis for four months. Clippings for growth rate and nutrient uptake (N, P and K) were taken every 30 days just prior to the next treatment application. Visual quality ratings were taken weekly.

Glasshouse Leaching Study: This study evaluated the effects of leaching only. No attempt was made to evaluate runoff in light of previous studies where virtually no runoff was collected on a sloping sand grow-in study. For the most part our studies have suggested that very little if any runoff occurs in a mature turfgrass setting. This study was established in controlled environment glasshouse setting using lysimeters to evaluate the leaching properties of the fertilizer materials. Turfgrass was established on the surface of PVC lysimeters (6 inches diameter by 18 inches deep) by sodding them with cut pieces of St. Augustine grass turf. Treatments were applied following a two week establishment period. The same six treatments outlined in the Growth and Quality Field Study were used in this study. Four replications of the treatments were arranged in a randomized complete block design and were rotated on a weekly basis within blocks to minimize the location effects of the glasshouse. The study was run for a total of 16 weeks. Clippings for dry weight and nutrient uptake (N, P and K) were taken monthly (or more often if excessive growth occurs). Leachates were collected every 30 days just prior to the next fertilizer application by applying 1 pore volume of water and analyzed for NO₃—N, NH₄—N, P, and K.

Granular Fertilizer Plus Wedge Study: Bermuda grass were sodded to tubs (18 inches by 24 inches) in a controlled glasshouse environment. Tubs were mounted at a 10 degree angle and a hole was cut in the bottom for leachate collection. After a two week establishment period treatments were applied in a randomized complete block design and replicated four times. Five treatments (1. Fertilizer—No Wedge (microorganisms); 2. 100% Fertilizer rate+Wedge; 3.75% Fertilizer rate+Wedge; 4.50% Fertilizer rate+Wedge; and 5. Wedge alone) were applied on a monthly basis. Clippings for growth rate and nutrient uptake (N, P and K) were taken every 30 days for a total of 4 harvests or 120 growth days. Quality ratings were taken weekly. Leachates were taken by applying pore volume of water every 30 days. Leachates were analyzed for NO₃—N, NH₄—N, P and K.

Liquid Fertilizer Plus Wedge Study: This study was conducted the same as Granular Fertilizer Plus Wedge Study except a liquid fertilizer was used.

Grow-in Using Wedge Study: Potentially the period of greatest environmental impact due to turfgrass fertilization occurs during grow-in because of the lack of coverage by the turfgrass and the high rates of fertilization and irrigation used. This study evaluated the influence of a biological material on grow-in rate and nutrient uptake efficiency of St. Augustine grass and Bermuda grass. Tubs (the same dimensions as above) were sprigged to Bermuda grass at the standard sprigging rate of 20 bushels per 1000 sq ft. A total of five treatments were applied to St. Augustine grass using a granular fertilizer formulation and to Bermuda grass using a liquid formulation on a weekly basis as follows: 1. 1 lb. N Granular Fertilizer; 2. 1 lb. N Granular Fertilizer+Wedge; 3. 0.75 lb. N Granular Fertilizer+Wedge; 4. 0.5 lb. N Granular Fertilizer+Wedge; 5. Wedge alone; 6. 1 lb. N Liquid Fertilizer; 7. 1 lb. N Liquid Fertilizer+Wedge; 8. 0.75 lb. N Liquid Fertilizer+Wedge; 9. 0.5 lb. N Liquid Fertilizer+Wedge; and 10. Wedge. Treatments 1-5 were applied to St. Augustine grass and 6-10 were applied to Bermuda grass. Rating for degree of coverage was taken weekly until full coverage was attained. Experimental units were maintained for a total of 12 weeks. Under normal grow-in conditions complete coverage is generally attained within 42-54 days. Clippings were collected for dry matter accumulation and nutrient uptake (N, P, K) as required or every 30 days after complete coverage was attained. Leachates were collected weekly and analyzed for NO₃—N, NH₄—N, P and K. At termination roots were extracted from the soil, dried and weighed for dry root mass.
Treatment of St. Augustine grass with a microbially enhanced inorganic fertilizer composition at 75% N resulted in a visual quality rating (indicating overall turf quality and density) of 6.21 which is greater than the minimum acceptable rating of 5.5 for St. Augustine grass.
Treatment of St. Augustine grass with a microbially enhanced inorganic fertilizer composition at 75% N resulted in root weights that were statistically equivalent to treatment with Turfbuilder, Lesco, and Pursell, all at 100% N.
Use of a microbially enhanced inorganic fertilizer composition at 75% N resulted in total dry matter accumulation on St. Augustine grass that was statistically equivalent to 100% N fertilization with Turfbuilder, Lesco, and Pursell.
The mean visual quality throughout the test was not significantly different between a microbially enhanced inorganic fertilizer composition at 75% N and Turfbuilder at 100% N, although it was reduced compared to the 100% N rate of the other two products.
On Bermuda grass, mean quality with a microbially enhanced inorganic fertilizer composition at 75% N was statistically equivalent to 100% N.
A key finding supports the premise that applied microorganisms coupled with a 25% reduction in fertilizer use can result in less fertilizer leaching. Treatment of Bermuda grass with a microbially enhanced inorganic fertilizer composition Bio-Nutrition at 75% N resulted in a 73% reduction in total leached N compared to the 100% N level.
With Bermuda grass, the average root dry weight from treatment with a microbially enhanced inorganic fertilizer composition at 75% N was not significantly different from that at the 100% N level.
Similarly, total dry matter accumulation and overall quality of Bermuda grass from treatment with a microbially enhanced inorganic fertilizer composition at 75% N was not significantly different from that at the 100% N level.
Overall quality of Bermuda grass was also not significantly different with the rate of a microbially enhanced inorganic fertilizer composition at 75% N compared to the 100% N level.
In a separate investigation to determine how treatments affected “grow in” (the rate at which the ground surface is covered with turf after “sprigging”) of St. Augustine grass, a microbially enhanced inorganic fertilizer composition at 75% N was not significantly different from the 100% N level. An additional treatment of the microbial component already present in a microbially enhanced inorganic fertilizer composition occurred.
In the same study, the tissue mass of St. Augustine grass, root weight, mean visual quality, and total N uptake resulting from a microbially enhanced inorganic fertilizer composition at 75% N was not significantly different from the 100% N level.
In the case of root dry weight, use of a microbially enhanced inorganic fertilizer composition at 50% was not significantly different from the 100% N level.
A key finding in this study was that the quantity of N leached was reduced by treatment with a microbially enhanced inorganic fertilizer composition at 75% N by 45% from the 100% N rate with added microbes and by 43% from the 100% N rate without added microbes.
In a separate study on growth rates of Bermuda grass, both the 75% N and 50% N rates of a microbially enhanced inorganic fertilizer composition resulted in the tissue dry weights as the 100% N rate. Note that in this study, all the treatments received added microorganisms, which may explain why the 50% N level results were equivalent to the higher N levels.
Similarly, the total dry mass was not significantly different among the 50%, 75%, and 100% N levels for a microbially enhanced inorganic fertilizer composition.
Total uptake of N, P, and K were not significantly different among the 50%, 75%, and 100% N levels for a microbially enhanced inorganic fertilizer composition.
The total N leached was reduced by 55% from the 100% N rate by treatment with a microbially enhanced inorganic fertilizer composition at 75% N. Treatment with a microbially enhanced inorganic fertilizer composition at 50% N reduced N leached by 86% of the control.
Total P leached was reduced from the control (100% N) by 45% with the 75% N treatment of a microbially enhanced inorganic fertilizer composition and by 78% with the 50% N rate.

### Example 6

Evaluating effects of a biological fertilizer (NA2101A) on tomato growth in south Florida reports a comparison of 100% recommended N fertilizer without microbes to 75% and 50% recommended N with the a microbially enhanced inorganic fertilizer composition microorganisms.

The experiment included three treatments: 1) Grower fertilizer rate 100% (Standard practice); 2) Grower fertilizer rate 100%+NA2101A (2 qt/ac in transplant water and 2 qt/ac at 14 days through drip); and 3) Grower fertilizer rate 75%+NA2101A (2 qt/ac in transplant water and 2 qt/ac at 14 days through drip). All treatments were replicated 4 times.

The trial was conducted on a Krome very gravelly loam soil. A typical polyethylene covered raised-bed was 36 in wide, 6 inch high and 72 inches apart. Fertilizer was applied at the rate of 100 lb N/ac using fertilizer 6N-6P205+12K20 for treatments 1 and 2 and the rate of 50 lb N/ac as a liquid fertilizer (4N-0P2O5-8K2O) injected weekly through irrigation system through a three month period.

‘Sanibel’ tomato plants were transplanted in a single row in the center of each bed with 20 inches between plants. NA2101A was applied as starter fertilizer during transplanting at the rate of 2 qt/ac and same amount of NA2101A was injected through irrigation system on Dec. 23. Soil and leaf samples were collected and were analyzed for P, K, Ca, Mg, Zn, Mn, Cu and Fe. Tomatoes were harvested two times, and the total number, total weight and color of fruit from each plot were recorded.

The following key results should be noted.
Treatment with 75% N plus a microbially enhanced inorganic fertilizer composition microorganisms resulted in yields of extra-large and total marketable fruit that were not significantly different from the 100% N rate.
Measurements of leaf greenness (SPAD readings) were only greater for the 100% N rate very early in the season (14 days after transplanting).
At 28, 42, and 88 days after transplanting, leaf greenness for plants treated with the 75% N rate plus a microbially enhanced inorganic fertilizer composition microorganisms was not significantly different from the 100% N rate.

### Example 7

The effect of a microbially enhanced inorganic fertilizer composition microbial amendment on St. Augustine grass quality and growth in south Florida investigates the effect of various treatment regimes of a microbially enhanced inorganic fertilizer composition microorganisms (a microbially enhanced inorganic fertilizer composition) at three rates of N-fertilizer.

The treatments included: 1. NA2102@4 qts/A+4 qts/A@14 days; 2. NA2102@4 qts/A+2 qts/A@14 days & 28 days; 3. NA2102@2 qts/A+2 qts/A@14 days, 28 days, & 42 days; 4. NA2102@4 qts/A+2 qts/A@14 days with 0.75 lbN/1000 ft² 16-4-8; 5. NA2102 @4 qts/A+2 qts/A@14 days with 0.50 lbN/1000 ft² 16-4-8; 6. 1.0 lbN/1000 ft² 16-4-8 only.

Materials and Methods:

The above treatments were initiated on ‘Floratam’ St. Augustine grass. Treatments were randomized within 6 replications of 1 m×2 m plots. Treatments were re-applied. Before re-application, plots were rated for quality and color (scale of 1-10 with 10=dark green turf, 1=dead/brown turf, and 6=minimally acceptable turf) and clipping samples were collected at a mowing height of 3.0 inches.

Ratings and clippings samples were taken throughout the experimental period. Soil cores were taken to an 8 inch depth with a 4-inch diameter cup cutter to determine root mass. All data was subject to statistical analysis and significant means were determined.

Key findings include the following points.
Treatment with 75% N plus a microbially enhanced inorganic fertilizer composition (treatment 4) resulted in quality ratings that were not significantly different to those from 100% N without microorganisms (treatment 6) on all 7 tested dates.
Treatment with 50% N plus a microbially enhanced inorganic fertilizer composition (treatment 5) resulted in quality ratings that were not significantly different to those from 100% N without microorganisms (treatment 6) on 5 of the 7 tested dates.
Color ratings resulting from treatment with 75% N plus a microbially enhanced inorganic fertilizer composition were not significantly different from treatment with 100% N without microorganisms at 6 of the 7 tested dates.
Dry weights of clippings resulting from treatment with 75% N plus a microbially enhanced inorganic fertilizer composition were statistically equivalent to those resulting from 100% N without microorganisms on all 4 test dates.
Dry weights from the 50% N plus a microbially enhanced inorganic fertilizer composition treatment were not significantly different from the 100% N without microorganism treatment on 3 of the 4 tested dates.

### Example 8

Alternative nitrogen sources for corn investigates the effect of a microbially enhanced inorganic fertilizer composition microorganisms on corn with three rates of N applied in two different forms. Hybrid: Select Seed Bt 902, at 30,000 seeds/acre. Soil: Hoytville clay with systemic tile drainage. Soil test values: P=45 ppm; K=177 ppm; pH=6.3. Previous crop: wheat. Tillage method: plowed, disked and land leveled twice. Fertilizer surface applied and incorporated with field cultivator just before planting. Plot Dimensions: 10×80 feet consisting of four rows, 30 inches apart.

Experimental Design: two factor completely randomized block replicated four times.

Fertilizer Treatments: three N rates (120, 160, 200 lb/a) of urea, Exp N, ESN (formerly called Duration), urea+Naturize's All Purpose Plant Bio-Nutrition Formula (APPBNF), Exp N+APPBNF and a zero N rate.

Statistical analysis: ANOVA, 3×5 factorial

Nitrogen fertilizer application: surface applied with a Gandy spreader and incorporated with a field cultivator prior to planting.

Ear-leaf Analysis: ten ear leaves were collected for plant analysis at growth stage R1.

Analysis was completed by Spectrum Analytic, Inc. (Washington Courthouse, Ohio).

Harvest populations: estimated by counting the number of plants in a 17.4 feet of each harvest row. The center two rows were harvested to estimate grain yield and moisture.

Key results include the following.
When nitrogen was supplied as urea, the addition of a microbially enhanced inorganic fertilizer composition's microorganisms, All Purpose Plant Formula (APPBNF) resulted in a yield at 160 lbs/A N of 140.9 bu/A, which was greater than the yield resulting from 200 lbs/A urea without microorganisms (137.4 bu/A).
Hence, the addition of microorganisms maintained yields with a 20% reduction in N (160 vsk 200 lbs N/A).
Note that N uptake at 160 lbs N/A with microorganisms (3.10%) was not higher from uptake at 200 lbs N/A without microorganisms (3.14%). Hence, the increased yield resulting at the 160 lb N rate with microorganisms compared to the 200 lb N rate without microorganisms is due to more than just N-uptake. This finding is consistent with past reports that the microorganisms in a microbially enhanced inorganic fertilizer composition benefit plants by causing several different effects.

### Example 9

Evaluating the effect of a microbially enhanced inorganic fertilizer composition on field corn development and yield at full and half fertilizer rates presents results of a study aimed at selecting the best mixture of a microbially enhanced inorganic fertilizer composition microorganisms. Treatments of microorganisms were compared at full and half-rates of starter fertilizer with or without side dressing. Key findings include the following.
Compared to the control of full starter fertilizer rate plus side dressing, one mixture of a microbially enhanced inorganic fertilizer composition microorganisms increased yield by 22%.
The best microbial mixture combined with half-rate of starter fertilizer (treatment 5) resulted in a yield increase of 15.7% over the rate of the full starter fertilizer control without microorganisms.

These data indicate the potential of inoculated beneficial microorganisms to promote plant growth. This technology also demonstrates that specific beneficial microorganisms can increase root growth with the resulting general effect of increasing nutrient utilization efficiency. The case studies presented show that a microbially enhanced inorganic fertilizer composition can be used to allow reductions in fertilizer input of at least 25%. Specific application regimes, and possibly microbial formulations, may be optimized for different crops and different regions of the country.

1.-10. (canceled)

11. A plant nutrient reduction system comprising:
a microbially enhanced inorganic fertilizer composition for application to a plant comprising,
a nitrogen:phosphorus:potassium (N:P:K) ratio wherein nitrogen is from 0 to about 32, phosphorus from 0 to about 13, and potassium from 0 to about 12, wherein at least one of nitrogen, phosphorus or potassium is at least about 2, and
at least about 1×10⁵ microorganisms per gram of fertilizer composition, wherein the application to a plant of the microbially enhanced inorganic fertilizer composition in an amount at least 25% less by weight than the application to a plant of a non-microbially enhanced inorganic fertilizer composition, results in comparable plant growth or yield in an equivalent time period.

12. The system of claim 11 wherein the N:P:K ratio comprises nitrogen from about 6 to about 32, phosphorus from about 4 to about 13, and potassium from about 3 to about 12.

13. The system of claim 11 wherein the microorganisms are present from at least about 1×10⁵ to about 5×10⁷ microorganisms per gram of fertilizer composition.

14. The system of claim 13 wherein the microorganisms are selected from the group consisting of bacteria, fungi, viruses or mixtures thereof.

15. A plant nutrient reduction system comprising:
a microbially enhanced inorganic fertilizer composition for application to a plant comprising,
a nitrogen:phosphorus:potassium (N:P:K) ratio wherein nitrogen is from 0 to about 32, phosphorus from 0 to about 13, and potassium from 0 to about 12, wherein at least one of nitrogen, phosphorus or potassium is at least about 2, and
at least about 1×10⁵ microorganisms per gram of fertilizer composition, wherein the application to a plant of the microbially enhanced inorganic fertilizer composition in an amount at least 25% less by weight than the application to a plant of a non-microbially enhanced inorganic fertilizer composition, results in comparable levels of nitrogen, phosphorus, or potassium in the plant.

16. The system of claim 15 wherein the N:P:K ratio comprises nitrogen from about 6 to about 32, phosphorus from about 4 to about 13, and potassium from about 3 to about 12.

17. The system of claim 15 wherein the microorganisms are present from at least about 1×10⁵ to about 5×10⁷ microorganisms per gram of fertilizer composition.

18. The system of claim 17 wherein the microorganisms are selected from the group consisting of bacteria, fungi, viruses or mixtures thereof.

19. The system of claim 15 wherein the application of the microbially enhanced inorganic fertilizer composition in an amount at least 25% less by weight than the application to a plant of a non-microbially enhanced inorganic fertilizer composition further results in comparable plant growth or yield in an equivalent time period.

20. A plant nutrient reduction system comprising:
a microbially enhanced inorganic fertilizer composition for application to a plant comprising,
a nitrogen:phosphorus:potassium (N:P:K) ratio wherein nitrogen is from 0 to about 32, phosphorus from 0 to about 13, and potassium from 0 to about 12, wherein at least one of nitrogen, phosphorus or potassium is at least about 2, and
at least about 1×10⁵ microorganisms per gram of fertilizer composition, wherein the application to a plant of the microbially enhanced inorganic fertilizer composition in an amount at least 25% less by weight than the application to a plant of a non-microbially enhanced inorganic fertilizer composition, results in residual levels of nitrogen, phosphorus, or potassium in the soil substantially less than that which results from the application to a plant of a non-microbially enhanced fertilizer composition.

21. The system of claim 20 wherein the N:P:K ratio comprises nitrogen from about 6 to about 32, phosphorus from about 4 to about 13, and potassium from about 3 to about 12.

22. The system of claim 20 wherein the microorganisms are present from at least about 1×10⁵ to about 5×10⁷ microorganisms per gram of fertilizer composition.

23. The system of claim 22 wherein the microorganisms are selected from the group consisting of bacteria, fungi, viruses or mixtures thereof.

24. The system of claim 20 wherein the application of the microbially enhanced inorganic fertilizer composition in an amount at least 25% less by weight than the application to a plant of a non-microbially enhanced inorganic fertilizer composition further results in comparable plant growth or yield in an equivalent time period.

25. The system of claim 20 wherein the application of the microbially enhanced inorganic fertilizer composition in an amount at least 25% less by weight than the application to a plant of a non-microbially enhanced inorganic fertilizer composition results in comparable levels of nitrogen, phosphorus, or potassium in the plant.
